(19) United States
(12) Patent Application Publication
(10) Pub. No.: US 2008/0101795 A1
(43) Pub. Date: May 1, 2008

(54) Data signal amplitude and cross-point detectors in an optical modulator control system

(76) Inventors: Craig Schulz, Fremont, CA (US); Thomas J. Giovannini, San Jose, CA (US); Gevorg Nahapetian, Pleasanton, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/588,750

(22) Filed: Oct. 27, 2006

(51) Int. Cl. H04B 10/08

(52) U.S. Cl. 398/25

(57) ABSTRACT

According to embodiments of the present invention, an optical modulator control apparatus receives a data signal and determines amplitude and cross-point of the data signal using a full wave detector. The apparatus sums the negative and positive halves of the data signal to determine the amplitude and differences the negative and positive halves of the data signal to determine the cross-point. Measurement of the amplitude may be independent of the cross-point.

### BACKGROUND

1. Field

Embodiments of the present invention relate to optical modulators and, in particular, to an optical modulator control system.

2. Discussion of Related Art

Optical networks use optical signals in telecommunication and enterprise networks to transmit and receive data and communications. Optical signals provide high-speed, superior signal quality and minimal interference from outside electromagnetic energy. Moreover, optical networks that use dense wavelength division multiplexing (DWDM) offer tunable multiple channel optical links.

To generate optical signals, optical networks may utilize optical modulators, such as Mach Zehnder modulators, for example. Various factors may affect the performance of optical modulators and control systems may be used to improve optical modulator performance.

### BRIEF DESCRIPTION OF THE DRAWINGS

In the drawings, like reference numbers generally indicate identical, functionally similar, and/or structurally equivalent elements. The drawing in which an element first appears is indicated by the leftmost digit(s) in the reference number, in which:

FIG. 1 is a high-level block diagram of optical system according to an embodiment of the present invention;

FIG. 2 is a graphical representation illustrating a data signal (or eye diagram) for use in the optical system depicted in FIG. 1 according to an embodiment of the present invention;

FIG. 3 is a detailed schematic diagram of the amplitude and cross-point detector depicted in FIG. 1 according to an embodiment of the present invention; and

FIG. 4 is a flowchart illustrating an approach to operating the amplitude and cross-point detector depicted in FIG. 1 according to an embodiment of the present invention.

### DETAILED DESCRIPTION OF EMBODIMENTS

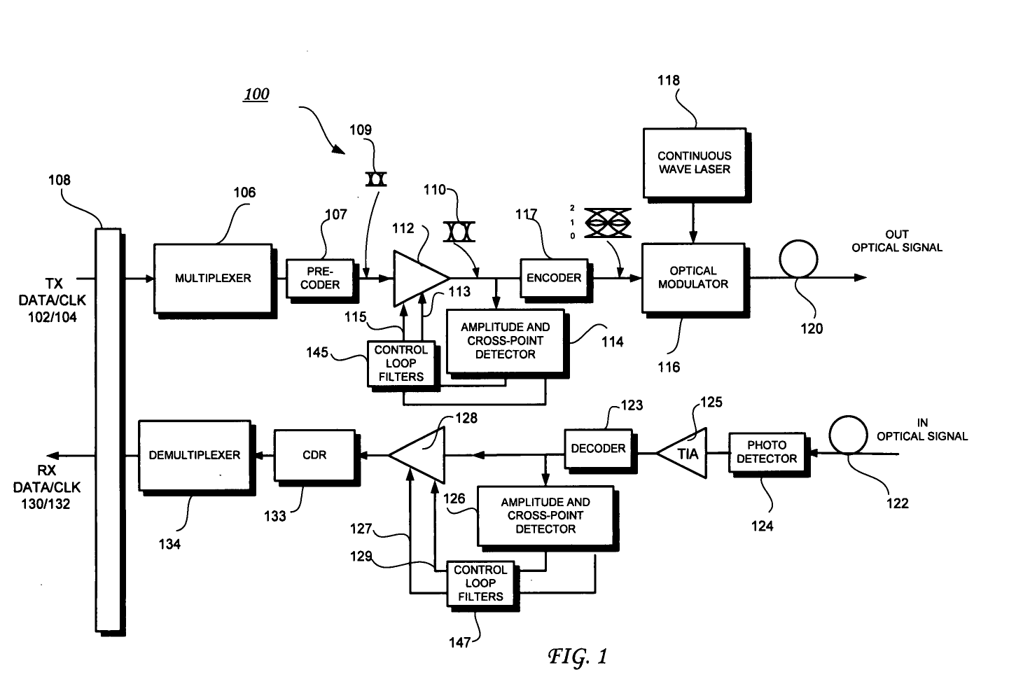

FIG. 1 is a high-level block diagram of optical system 100 according to an embodiment of the present invention. For some embodiments, the optical system 100 may be an optical transponder that transmits and/or receives data and other communications on an optical signal. For other embodiments, the optical system 100 may be an optical transceiver that transmits and/or receives data and other communications on an optical signal.

In the illustrated embodiment, on the transmit side of the optical system 100 data 102 and a clock 104 are input to a multiplexer 106 via a connector 108. The output of the multiplexer 106 is coupled to a pre-coder 107, which is coupled to a driver 112. The driver 112 is coupled to an amplitude and cross-point detector 114 and an encoder 117. The encoder 117 is coupled to an optical modulator 116. There is a control loop filter 145, which outputs an amplitude control signal 113 and a cross-point control signal 115 for the driver 112. The optical modulator 116 is coupled to a continuous wave laser 118 and to an optical fiber 120. The output of the optical fiber 120 is an optical signal, which is transmitted from the optical system 100.

On the receive side in the illustrated embodiment, an optical signal is input into the optical system 100 via an optical fiber 122. The optical fiber 122 is coupled to a photodetector 124, which is coupled to a transimpedance amplifier (TIA) 125. The TIA 125 is coupled to a decoder 123 and to a second, optional amplitude and cross-point detector 126. The decoder 123 is coupled to an amplifier 128. The amplifier 128 is coupled to a clock and data recover (CDR) circuit 133, which is coupled to a demultiplexer 134. There is a control loop filter 147, which outputs an amplitude control signal 127 and a cross-point control signal 129 for the amplifier 128. Data 130 and a clock 132 are output from the demultiplexer 134 via the connector 108.

In one embodiment, the data 102 may be sixteen synchronized data lines. The clock signal 104 may clock the data 102. The connector 108 may be a 300-pin multi-source agreement (MSA) connector, an XFP connector, a XENPAK connector, or other suitable connector capable of coupling the data signal 102 and the clock 104 to the multiplexer 106.

The multiplexer 106 may be a sixteen-to-one multiplexer. For this embodiment, the multiplexer 106 may multiplex the sixteen data lines from the connector 108 to form a data stream.

The data stream output from the multiplexer 106 may be a ten gigabit per second (10 Gbps) serial data stream. The data stream may be a two-level non-return-to-zero (NRZ) binary encoded data stream.

The data stream may then be pre-coded using the pre-coder 107. For some embodiments, the pre-coder 107 may perform duo-binary pre-coding or other suitable pre-coding on the data stream output from the multiplexer 106. Alternatively, the data stream may be an un-encoded NRZ signal. In this embodiment, the pre-coder 107 may not be used to perform pre-coding on the output of the multiplexer 106.

The pre-coded signal 109 may be input into the driver 112 for amplification. The driver 112 may be any circuitry suitable for boosting the amplitude of the pre-coded signal 109 to be compatible with the optical modulator 116. The output of the driver is a signal 110. The example signal 110 is illustrated as an NRZ signal. The signal 110 may be fairly balanced in that it may have the number of logical ones and the number of logical zeros substantially equal to each other.

The signal 110 may then be input into the encoder 117. The encoder 117 may perform duo-binary encoding on the signal 110. The illustrated output of the encoder 117 is a three-level duo-binary encoded signal. For embodiments in which the data stream may be an un-encoded NRZ signal, the encoder 117 may not be used to perform encoding on the output of the amplifier 112.

The optical modulator 116 may convert the signal 110 to an optical signal using light from the continuous wave laser 118. The optical modulator 116 may be any suitable optical modulator, such as a lithium niobate (LiNbO₃) Mach-Zehnder modulator, for example.

The continuous wave laser 118 may be any suitable laser, such as a temperature tuned external cavity laser, for example. The optical signal may be launched into the optical fiber 120.

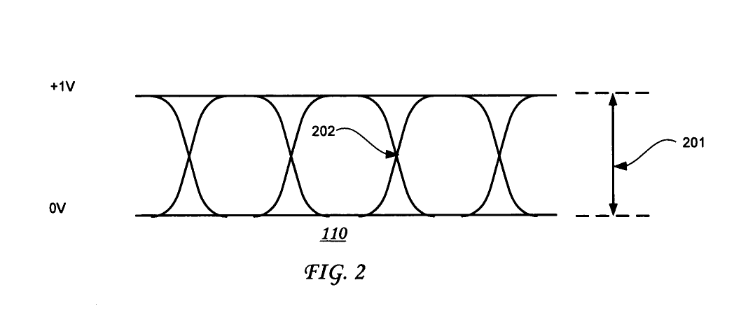

FIG. 2 is a graphical representation of an eye pattern or eye diagram illustrating the signal 110 according to an embodiment of the present invention. In the illustrated embodiment, the signal 110 includes the data bits acquired from the data stream overlaid on top of each other and includes amplitude 201 and cross-point 202. The amplitude 201 may be the peak-to-peak voltage level of the signal 110. The cross-point 202 may be the amplitude at which the signal 110 crosses into the next bit window.

The amplitude of the signal 110 may vary due to temperature changes or aging of the optical system 100, for example. For some embodiments, the detector 114 may measure the amplitude of the signal 110. The detector 114 may tap a portion of the signal 110 to determine the amplitude the amplified signal 110. The control loop filters 145 may determine an error between the measured amplitude and a predetermined amplitude of the signal 110. The control loop filters 145 may update the control signal 113 using the error. The updated control signal 113 may be coupled to the driver 112. The driver 112 may use the updated control signal 113 to control the amplitude of the signal 110 output from the driver 112.

The cross-point 202 of the signal 110 also may vary due to temperature changes or aging of the optical system 100, for example. For some embodiments, the detector 114 may determine the cross-point of the signal 110. The detector 114 may tap a portion of the signal 110 to determine the cross-point of the signal 110. The control loop filters 145 may determine an error between the measured cross-point and a predetermined cross-point of the signal 110. The control loop filters 145 may update the controls signal 115 using the error. The updated control signal 115 may be coupled to the driver 112. The driver 110 may use the updated control signal 115 to control the cross-point setting for the signal 110 output from the driver 112.

For some embodiments, the amplitude measurement of the signal 110 may be independent from the cross-point of the signal 110. That is, a change in the cross-point of the signal 110 may not affect the measurement of the amplitude of the signal 110. Similarly, a change in the amplitude of the signal 110 may not affect the measurement of the cross-point of the signal 110.

The decoder 123 may decode the signal for embodiments in which the input optical signal is encoded. The amplifier 128 amplifies the signal output from the TIA 125 or optionally from the decoder 123.

For some embodiments, the CDR 133 may recover the clock 132 from the incoming signal, make the decision as to whether an incoming bit is a logical one or a logical zero, and re-clock the data 130. In embodiments in which the signal 110 is a pre-coded duo-binary data stream, the CDR 131 may use single consecutive bits to reconstruct the data stream in the received signal.

The demultiplexer 134 may separate the clock 132 and the data 130 into sixteen data lines.

The optional detector 126, control loop filters 147, and the two control signals 127 and 129 may operate in a manner similar to that described with reference to the transmit side of the optical system 100.

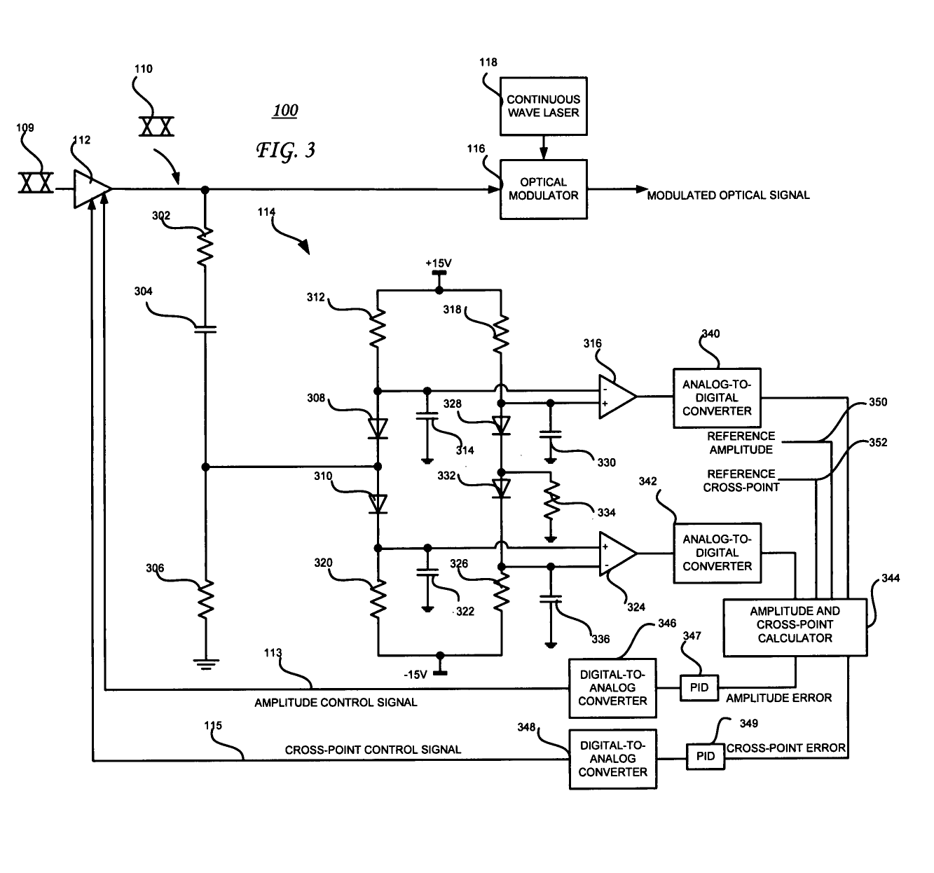

FIG. 3 is schematic diagram of the optical system 100 according to an alternative embodiment of the present invention. The illustrated embodiment shows the signal 110 coupled to the driver 112, the driver 112 coupled to the optical modulator 116, and the optical modulator 116 coupled to the continuous wave laser 118.

The illustrated embodiment shows the amplitude and cross-point detector 114 tapping a portion of the signal 110. The detector 114 includes a resistor 302 having one terminal coupled between the driver 112 output and the optical modulator 116 input. A second terminal of the resistor 302 is coupled to one terminal of a capacitor 304. A second terminal of the capacitor 304 is coupled to one terminal of a resistor 306, to the cathode of a diode 308, and to the anode of a diode 310. The second terminal of the resistor 306 is coupled to ground (0V).

The anode of the diode 308 is coupled to one terminal of a resistor 312, one terminal of a capacitor 314, and to one terminal of an operational amplifier 316. The second terminal of the resistor 312 is coupled to a plus fifteen volts supply (+15V) and to a terminal of a resistor 318. The second terminal of the capacitor 314 is coupled to ground (0V).

The cathode of the diode 310 is coupled to one terminal of a resistor 320, one terminal of a capacitor 322, and to one terminal of an operational amplifier 324. The second terminal of the resistor 320 is coupled to a minus fifteen volts supply (−15V) and to a terminal of a resistor 326. A second terminal of the capacitor 322 is coupled to ground (0V).

A second terminal of the operational amplifier 316 is coupled to the anode of a diode 328 and to a terminal of a capacitor 330. A second terminal of the capacitor 330 is coupled to ground (0V). The cathode of the diode 328 is coupled to the anode of a diode 332 and to one terminal of a resistor 334. A second terminal of the resistor 334 is coupled to ground (0V). A second terminal of the operational amplifier 324 is coupled to the cathode of the diode 332, to a second terminal of the resistor 326, and to a terminal of a capacitor 336. A second terminal of the capacitor 336 is coupled to ground (0V).

In the illustrated embodiment, an output of the operational amplifier 316 is coupled to an analog-to-digital converter (ADC) 340. An output of the operational amplifier 324 is coupled to an analog-to-digital converter (ADC) 342. Outputs of the analog-to-digital converters (ADC) 340 and 342 are coupled to an amplitude and cross-point calculator 344. The outputs of the calculator 344 are coupled to two proportional-integral-derivative (PID) controllers 347 and 349, which are coupled to two digital-to-analog converters (DAC) 346 and 348. Outputs of the two digital-to-analog converters (DAC) 346 and 348 are coupled to the driver 112 to form a closed loop. A reference amplitude 350 and a reference cross-point 352 are input into the calculator 344.

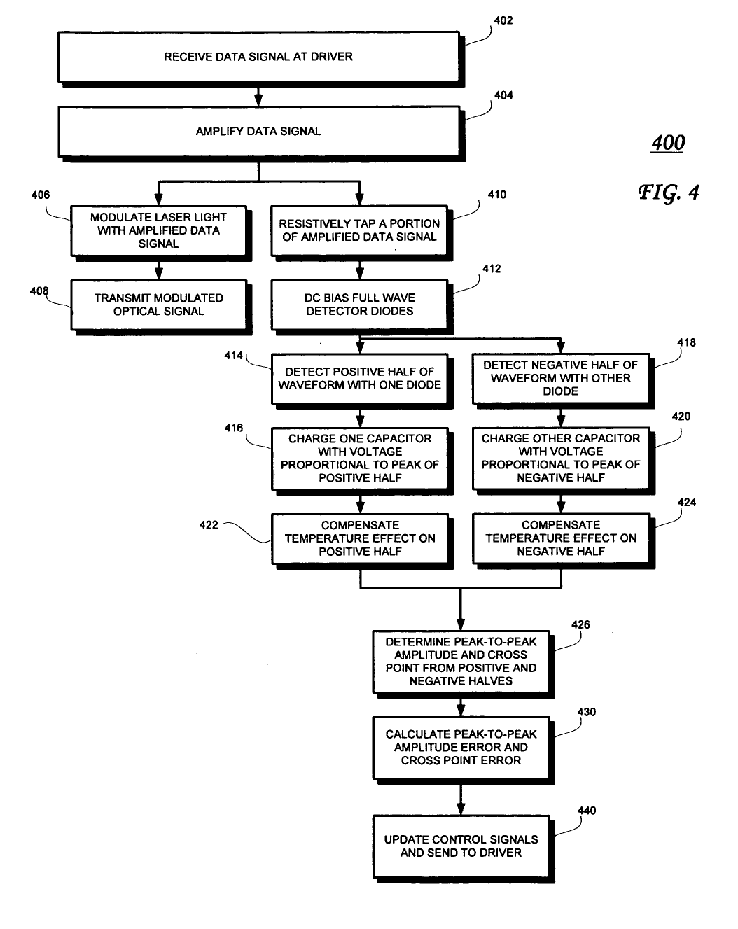

FIG. 4 is a flowchart illustrating an approach to operating the optical system 100 depicted in FIG. 4 according to an embodiment of the present invention. For ease of explanation the amplitude and cross-point detector will be described with reference to the amplitude and cross-point detector 114. However, the description may apply equally to the amplitude and cross-point detector 126 and/or other amplitude and cross-point detectors implemented in accordance with embodiments of the present invention.

In block 402, the driver 112 receives the signal 109.

In block 404, the driver 112 may amplify and set the cross-point of the signal 109. In block 406, the optical modulator 116 may modulate the laser light from the continuous wave laser 118 with the signal 110 to produce an optical signal at the data rate of the signal 110. In block 408, the optical modulator 116 may launch the optical signal into the optical fiber 120.

In block 410, the detector 114 may resistively tap a portion of the amplified signal 110. For example, the resistor 302 and the capacitor 304 may form a leg that diverts a small portion of the data stream to the diodes 308 and 310. The diodes 308 and 310 form a full wave detector, with the diode 308 detecting the negative portion of the signal 110 waveform and the diode 310 detecting a positive portion of the signal 110 waveform out of phase.

In block 412, the diodes 308 and 310 are direct current (DC) biased. In the illustrated embodiment, resistors 312 and 320 provide DC biasing for the diodes 308 and 310 using the +15V and −15V supply. The DC biasing may provide a constant current source for the diodes 308 and 310, to bias them in their optimal detection range, for example. The capacitor 304 may isolate the DC bias voltage from the driver 112.

In block 414, the positive half of the signal 110 is detected. In the illustrated embodiment, the diode 310 detects the positive half of the signal 110 waveform.

In a block 416, the capacitor 322 charges up to a voltage that is proportional to a peak value of the positive half of the signal 110 waveform. In block 418, the negative half of the signal 110 is detected. In the illustrated embodiment, the diode 308 detects the negative half of the signal 110 waveform. In block 420, the capacitor 314 charges up to a voltage that is proportional to a peak value of the negative half of the signal 110 waveform. The output of the capacitor 314 is applied to the operational amplifier 316 inverting input and the output of the capacitor 322 is applied to the non-inverting input of the operational amplifier 324.

In blocks 422 and 424 diode temperature effects on the positive and negative halves, respectively, of the signal 110 waveform may be subtracted out. In the illustrated embodiment temperature compensation may be provided by a leg formed by the diodes 328 and 332, the capacitors 330 and 336, and resistors 318, 326, and 334. There may be a current path through the leg. The operational amplifiers 316 and 324 may subtract out the temperature effect based on the inputs on their non-inverting and inverting inputs, respectively. The output of the operational amplifiers 316 and 324 may be a true detected waveform not dependent on temperature.

In block 426, the peak-to-peak amplitude and cross-point may be determined from the positive and negative halves of the signal 110 waveform. In one embodiment, the calculator 344 may determined the peak-to-peak amplitude level of the signal 110 waveform by summing the value of the negative half of the signal 110 waveform with the value of the positive half of the signal 110 waveform. The calculator 344 also may determine the cross-point level of the signal 110 waveform by dividing the difference between the value of the negative half of the signal 110 waveform and the value of the positive half of the signal 110 waveform by the sum of the value of the negative half of the signal 110 waveform and the value of the positive half of the signal 110 waveform. In one embodiment, the outputs of the operational amplifiers 316 and 324 are converted to digital signals using the analog-to-digital converters 340 and 342, respectively.

In block 430, the error between the measured amplitude and the reference amplitude 350 as well as the error between the measured cross-point and a reference cross-point 352 may be determined. In one embodiment, the calculator 344 may compare the measured amplitude of the signal 110 waveform with the reference amplitude 350 to generate the amplitude error. The PID 347 may run the amplitude error through a suitable PID servo control algorithm and output an updated amplitude control value based on the amplitude error. The digital-to-analog convert 346 may convert the amplitude control signal from the PID 347 to the amplitude control signal 113. The calculator 344 may compare the measured cross-point of the signal 110 waveform with the reference cross-point 352 to generate the cross-point error. The PID 349 may run the cross-point error through a suitable PID servo control algorithm and output an updated cross-point control value based on the cross-point error. The digital-to-analog convert 348 may convert the digital cross-point value from the PID controller 349 to the analog cross-point control signal 115.

In block 440, the control signals 113 and 115 may be updated and sent to the driver 112.

For some embodiments, the PID 347 and/or the PID 349 may be a microcontroller with firmware. For other embodiments, the PID 347 and/or the PID 349 may be analog circuitry.

Embodiments of the present invention may be implemented using hardware, software, or a combination thereof. In implementations using software, the software or machine-readable data may be stored on a machine-accessible medium. The machine-readable data may be used to cause a machine, such as, for example, a processor (not shown) to perform the process 500.

A machine-readable medium includes any mechanism that may be adapted to store and/or transmit information in a form accessible by a machine (e.g., a computer, network device, personal digital assistant, manufacturing tool, any device with a set of one or more processors, etc.). For example, a machine-readable medium includes recordable and non-recordable media (e.g., read only (ROM), random access (RAM), magnetic disk storage media, optical storage media, flash devices, etc.), such as electrical, optical, acoustic, or other form of propagated signals (e.g., carrier waves, infrared signals, digital signals, etc.).

In the above description, numerous specific details, such as, for example, particular processes, materials, devices, and so forth, are presented to provide a thorough understanding of embodiments of the invention. One skilled in the relevant art will recognize, however, that the embodiments of the present invention may be practiced without one or more of the specific details, or with other methods, components, etc. In other instances, structures or operations are not shown or described in detail to avoid obscuring the understanding of this description.

Reference throughout this specification to “one embodiment” or “an embodiment” means that a particular feature, structure, process, block, or characteristic described in connection with an embodiment is included in at least one embodiment of the present invention. Thus, the appearance of the phrases “in one embodiment” or “in an embodiment” in various places throughout this specification does not necessarily mean that the phrases all refer to the same embodiment. The particular features, structures, or characteristics may be combined in any suitable manner in one or more embodiments.

The terms used in the following claims should not be construed to limit embodiments of the invention to the specific embodiments disclosed in the specification and the claims. Rather, the scope of embodiments of the invention is to be determined entirely by the following claims, which are to be construed in accordance with established doctrines of claim interpretation.

What is claimed is:

1. A method, comprising:
receiving a data signal in an optical transmitter and/or receiver;
determining an amplitude of the data signal; and
determining a cross-point of the data signal.

2. The method of claim 1, wherein determining the amplitude comprises summing a detected value of a negative half of the data signal and a detected value of a positive half of the data signal.

3. The method of claim 2, further comprising compensating for temperature effects on the detected value of the negative half and/or the positive half of the data signal.

4. The method of claim 1, wherein determining the cross-point comprises:
summing a detected value of a negative half of the data signal and a detected value of a positive half of the data signal;
differencing the detected value of the negative half of the data signal and the detected value of the positive half of the data signal; and
dividing the difference between the detected values of the negative and positive halves of the data signal by the sum of the negative and positive halves of the data signal.

5. The method of claim 4, further comprising compensating for temperature effects on the detected value of the negative half and/or the positive half of the data signal.

6. The method of claim 1, wherein determining the amplitude of the data signal is independent of the cross-point.

7. An apparatus, comprising:
an optical device having:
a first detector circuit to detect a positive half of a data signal from a driver;
a second detector circuit to detect a second half of the data signal;
circuitry to determine an amplitude of the data signal by summing a value of a negative half of the signal and a value of a positive half of the data signal, the circuitry further to determine a cross-point of the data signal by differencing the value of the negative half of the data signal and the value of the positive half of the data signal and dividing the difference between the values of the negative and positive halves of the data signal by the sum of the negative and positive halves of the data signal.

8. The apparatus of claim 7, wherein the first and second detector circuits comprise a first diode and a second diode, respectively, coupled to a first operational amplifier and a second operational amplifier, respectively.

9. The apparatus of claim 8, wherein the first and second detector circuits further comprise a first capacitor and a second capacitor, respectively, coupled to the first and second operational amplifiers, respectively, and to the first and second diodes, respectively.

10. The apparatus of claim 10, wherein the first and second detector circuits further comprise direct current (DC) biasing circuitry to supply a substantially constant current to the first and second diodes.

11. The apparatus of claim 10, wherein the first and second detector circuits further comprise temperature compensation circuitry coupled to the first and second operational amplifiers to compensate for temperature variations of the first and second diodes, respectively.

12. The apparatus of claim 8, wherein the circuitry to determine the amplitude of the data signal and the cross-point comprises a first analog-to-digital converter and a second analog-to-digital converter coupled to the first operational amplifier and the second operational amplifier, respectively.

13. The apparatus of claim 12, wherein the circuitry to determine the amplitude of the data signal and the cross-point comprises a microcontroller coupled to the first and second analog-to-digital converters.

14. The apparatus of claim 13, further comprising a first digital-to-analog converter and a second digital-to-analog converter coupled to the microcontroller.

15. The apparatus of claim 14, wherein a first output of the first digital-to-analog controller and a second output of the second digital-to-analog converter are coupled to the driver.

16. The apparatus of claim 8, wherein the circuitry to determine the amplitude of the data signal and the cross-point of the data signal comprises analog circuitry coupled to the first operational amplifier and the second operational amplifier.

17. The apparatus of claim 16, wherein the analog circuitry is coupled to the driver.

18. A system, comprising:
an optical device having:
a full wave detector to detect a first half of a data signal and a second half of the data signal;
circuitry to determine an amplitude level of the data signal by summing a detected value of a negative half of the signal and a detected value of a positive half of the signal, the circuitry further to determine a cross-point of the data signal by differencing the detected value of the negative half of the data signal and the detected value of the positive half of the data signal and dividing the difference between the detected values of the negative and positive halves of the data signal by the sum of the negative and positive halves of the data signal; and
a 300-pin connector coupled to the optical device.

19. The system of claim 18, wherein the amplitude control signal and the cross-point control signal are coupled to the driver.

20. The system of claim 18, wherein the circuitry to determine the amplitude of the data signal operates independently of the cross-point of the data signal.
